(19) United States
(12) Patent Application Publication
(10) Pub. No.: US 2012/0265487 A1
(43) Pub. Date: Oct. 18, 2012

(54) Method and Apparatus of Analyzing Sample Surface Data

(75) Inventors: Emilio Yanine, Tucson, AZ (US); Paul R. Unruh, Oro Valley, AZ (US); Jon D. Herron, JR., Tucson, AZ (US); Michael B. Krell, Tucson, AZ (US); Son H. Bui, Tucson, AZ (US); Joseph P. Moore, Tucson, AZ (US); Dmitriy K. Kiselev, Tucson, AZ (US); Ross O. Smith, Palo Alto, CA (US)

(73) Assignee: BRUKER NANO, INC.

(21) Appl. No.: 13/111,789

(22) Filed: May 19, 2011

Related U.S. Application Data
(60) Provisional application No. 61/476,176, filed on Apr. 15, 2011.

(51) Int. Cl. G06F 15/00; G01B 21/20

(52) U.S. Cl. 702/168; 702/167

(57) ABSTRACT

An improved apparatus and method for the analysis of surface data collected using a sub-micron scale metrology instrument which provides a persistent user experience by allocating set portions of the display to major functional regions thereby allowing a quick to learn and easy to user interface for the setup, analysis, and display of microscopic 3D surface data measurements and resulting analytic data with a variety of 3D surface scanners.

### BACKGROUND OF THE INVENTION

1. Field of the Invention

The present invention is directed to the field of 3D surface metrology; in particular, scanning microscopes, and more particularly, to an apparatus which collects, analyzes, and displays the multi-dimensional surface characteristic data collected by the scanning microscopes.

2. Description of Related Art

Scanning probe microscopes such as scanning probe microscopes (SPMs), atomic force microscopes (AFMs), interferometric optical profilers, confocal microscopes, and the like are devices which typically collect multi-dimensional surface data to characterize the observed sample's surface down to sub-micrometer and atomic dimensions. Generally, the data is collected in some type of path such as a raster scan or other trajectory which locates the surface in three dimensions and returns information about the surface characteristics. By providing relative scanning movement between the sensor (the device that gathers the surface data, such as an interferometric sensor, contact probe, or confocal instrument) and the sample, surface characteristic data can be acquired over a particular region of the sample, and a corresponding multi-dimensional map of the sample's surface characteristics can be generated.

Scanning probe microscopes can obtain resolution down to the atomic level on a wide variety of insulating or conductive surfaces in air, liquid or vacuum by using piezoelectric scanners, optical lever deflection detectors, optical point illumination, and so forth. Because of their resolution and versatility these microscopes are very important measurement devices in many diverse fields ranging from semiconductor manufacturing to biological research.

Advanced 3D surface metrology systems often present a challenge to user interface design because of the inherent clash between the desire to provide an easy, intuitive interface and the need to make accessible all the available controls and myriad of functions associated with such systems, which are required to maximize the capabilities of these powerful instruments. Of course, with the latter being generally more important than the former. There has been a complimentary need for expert users, otherwise the full power of these tools cannot be utilized. Notably, this has somewhat limited the broad acceptance of some metrology tools.

Managing such complexity must take into account not only the various modes of operation for the instrument but also the different types of operators that use it. Various methods exist to deal with this issue such as wizards, dialogs, custom interfaces, and context sensitive help among others. However, this often results in too many interface windows and dialogs that require cumbersome navigation on the part of the user; or in the case of custom interfaces, reduce functionality or significant engineering effort to customize the interface for various applications and/or users.

What was needed then is an easy to learn and an intuitive interface that allows for quick completion of user tasks while avoiding the problems of user confusion, error, slow user response times, more difficult and timely learning curves, and so forth.

### SUMMARY OF THE INVENTION

The present invention is an apparatus and method for collection and analysis of microscopic surface data that provides a graphical user interface (GUI) layout designed for advanced metrology instrumentation for 3D surface data where the instrument control functions and data analysis functions coexist and share the same display real estate in an intelligent fashion to make the full system functionality available to the user in a more intuitive fashion and with significantly less work.

The invention here is an intelligent user software interface layout that seeks to expose as much functionality at the top level for easy access with very few clicks and without the clutter of multiple overlapping windows competing for the display real estate. The paradigm for this interface is similar to a cockpit found on other complex instruments that emphasizes usability. The screen is divided into specific areas that are locked in place relative to each other. Moreover, these areas can be reused, depending on the mode the system is in, i.e. measurement, analyses, online help, support, web browsing, etc. With this design, the users can predictably and efficiently find the function or control they are looking for with fewer clicks than in more traditional document-view model type interfaces.

In accordance of one aspect of the invention the user interface provides no overlapping windows and minimal dialog boxes for a substantial number of the invention's operating modes. The surface analyzer may have a sensor (providing a surface measurement data from an object), a display, a user input device, processing elements (for processing the surface measurement data), and a user interface display region having visual regions within. The major visual regions of the display are a data visualization window, a measurement control panel, a data analyzer window, and an active data gallery. Importantly, the visual regions are simultaneously displayed in a persistent location and size relative to the user interface display region.

Thus it is one advantage of the invention to offer a fixed user interface similar to that of hardware displays such as in a cockpit, which are immutable due to their physical hardware, and thus easier to memorize and access.

In accordance with yet another aspect of the invention, the data analyzer window has processing elements for processing the surface measurement data which can be applied to using the user input device (such as a mouse or touch screen) to select and apply the processing element(s) in a single user input device operation. The invention also provides a data visualization window with various display modes for representation of the surface measurement data and characteristics. The display mode may be easily selected by the user input device in a single user input device operation.

Thus, it is another advantage of the invention to offer a quick and easy device for processing the surface data and selecting how to display the results.

In yet another aspect of the invention the surface analyzer may have a control panel providing control elements that allow selection of measurement type, measurement area, a measurement multiplier, measurement magnification, and measurement illumination, wherein each and every control element setting may be selected by the user input device in a single user input device operation.

Thus, it is yet another advantage of the invention to offer a quick and easy device for controlling the measurement of the surface data.

According to one another aspect of the invention, the active data gallery provides one or more selections for previously collected surface measurement data, wherein each and every previously collected surface measurement may be selected by the user input device in a single user input device operation. Thus, it is yet another advantage of the invention to offer a quick and easy device for organizing and recalling the previously collected and/or analyzed surface data.

According to one aspect of the invention, a method of operating a surface analyzer is used to measure the surface of a sample by 1) setting up the surface analyzer to measure the sample; 2) operating the surface analyzer to collect the surface data; 3) applying one or more processing elements (i.e. processing sequence) to the surface data so as to produce processed surface data; 4) viewing representations of the surface data or the processed surface data on a display; and 5) saving the processing sequence, the surface data, and/or the processed surface data. The processed surface data may provide surface information such as surface location, indentations, adhesion, hardness, and elasticity. In addition, the processing sequence may be previously defined in a user saved processing sequence or a default processing sequence.

Thus, it is one advantage of the invention to provide a simple method for collecting, analyzing, and saving surface data as well as saving the processing sequence(s) for ease of use.

According to another aspect of the invention, more than one representation of the surface data that has been processed by a plurality of processing sequences may be displayed. A selector may be used for displaying the representations of the surface data or the processed surface data on the display simultaneously.

It is, thus, another advantage of the invention to provide for side-by-side or simultaneous viewing and analysis of processed surface data sets using differing processing sequences and the same or differing surface data as inputs.

In another aspect of the invention the representation of the processed surface data may be a measurement, a parameter, a plot, and a surface rendering of the sample. Thus, providing the advantage of multiple forms to view the analyzed data.

In yet another aspect of the invention, one or more processing elements may be used to transform one or more sets of the surface data or processed surface data using, for example, a real-time filter, a post-processing filter, a data combining operation, a data masking operation, a frequency transform, an inversion, a subtraction, an estimator, and so forth. In addition, more sophisticated processing elements which analyze the data may be used which transform one or more sets of the surface data or processed surface data to produce an analysis of said data (for example: height histograms, filtered height histograms, multiple-regions statistical analysis, power spectral density, cross hatch analysis, mean surface roughness, root mean square surface roughness, root mean square surface slope, mean summit curvature, summit density, surface texture aspect ratio, feature statistics analysis, surface texture skewness, surface texture kurtosis, average distance between highest and lowest points, step height, digitally filtered stylus analysis, hypothetical Zernike wavefront analysis, material volume estimate, void volume estimate, and so forth).

Thus, it is one advantage to provide a toolbox of various processing elements to yield sophisticated and powerful results with minimal user interaction.

In yet another aspect of the invention the surface analyzer has a sensor (providing a surface measurement data from a sample), processing elements for processing the surface measurement data, and a user interface with a display screen and a user input device such as a mouse. The processing elements may be selected individually or as a group, ordered by the user into a processing sequence, and applied to the surface measurement data to produce processed surface data wherein a representation of the processed surface data may be is displayed. The sensor may be an interferometric sensor, a contact probe, a confocal instrument, and the like. The surface analyzer may also include a controller for positioning the sensor, measurement setup, real-time measurement interaction, and a surface data collection.

Thus, it is another advantage of the present invention to provide an entire sensor to analysis and display solution wherein the user may control, analyze and view the surface data within a single device/application.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is an isometric view of an embodiment of the present invention showing a sample, a sensor, and a workstation;

FIG. 2 is a simplified diagram of the user interface of the present invention showing the major regions of the interface;

FIG. 3 is a screenshot of the user interface of an embodiment of the present invention showing data collection and analysis of a sample;

FIG. 4 is a section of the user interface of the embodiment of FIG. 3 showing, primarily, the main display area, but also display tabs and a data visualization taskbar;

FIG. 5 is a section of the user interface of FIG. 3showing the measurement control panel;

FIG. 6 is a section of the user interface of FIG. 3 showing the data analysis area;

FIG. 7 is a section of the user interface of FIG. 3 showing the active data gallery;

FIG. 8 is a screenshot of the user interface of an embodiment of the present invention showing simultaneous comparative analysis of the same sample;

FIGS. 9A and 9B are screenshots of the process windows, sequences and trees presented via the GUI of the preferred embodiments; and

FIG. 10 is a flow diagram illustrating a method of collection and analysis of data concerning a sample according to the preferred embodiments.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DETAILED DESCRIPTION OF THE PREFERRED EMBODIMENTS

The preferred embodiments are directed to surface analyzers, such as a scanning microscope, an apparatus which collects, analyzes, and displays the multi-dimensional surface characteristic data from the scanning microscope sensor while providing an efficient full-featured user interface for defining and implementing data collection from a sample, as well as post-collection analyses that may have multiple analysis processes applied for side-by-side comparisons. Moreover, because all user interface control and display areas are simultaneously displayed, the control of the device and the display of data, contrary to prior art systems, is intuitive, fast to learn, and easy to use.

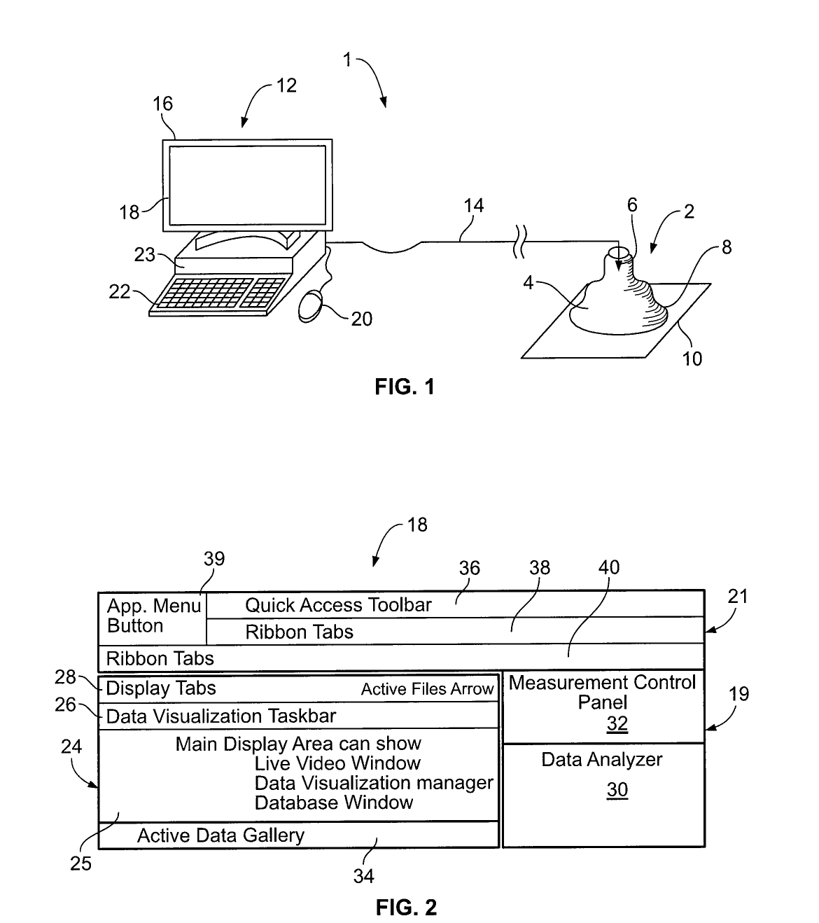

Referring now to the Figures, in particular to FIG. 1, a preferred embodiment 1 of the present invention is shown including a sample 2 whose surface data characteristics are being collected and analyzed. The sample 2 has an outer surface 4 from which the sensor 6 may collect data about the surface characteristics of sample 2. Although the scanning microscope may have any of a variety of 3D scanning sensors, the sensor is shown as the probe tip 6 of a scanning probe microscope (SPM).

In alternative embodiments the sensor may be a probe for an atomic force microscope (AFM), one or more light emitters/optical sensors such as for an interferometric optical profiler, a confocal microscope, and the like.

In the embodiment of FIG. 1 the probe 6 of surface analyzer 1 traverses the surface 4 of the sample 2. The surface 4 of the sample traversed may be masked at contour line 8 such that surfaces below the plane 10 are not collected. The path followed by the sensor probe 6 may be a raster scan, alternatively, some other user-defined or default path as will be explained below.

The data collected by the probe 6 is transmitted to the main workstation 12 along some communications channel such as a wired connection 14 (in alternative embodiments the sensor data may be transmitted wirelessly). The user (not shown) interacts with the present invention with main workstation 12 by utilizing monitor 16 for controlling the collection of surface data and viewing a variety of information about sample 2 in display area 18 as will be explained below. In addition, the workstation 12 may have a main processing unit shown as stand-alone enclosure 23 or it may be integrated into the display (not shown). The user also utilizes input devices such as mouse 20 and keyboard 22 for various operations. Other preferred embodiments, however, may utilize one or more of a variety of input devices such as track pad, track ball, touch screen, and the like.

Turning now to FIG. 2, the display area 18 is composed of major regions, each receiving a fixed part of the display area 18. The major regions include the data visualization window shown as Main Display area 24, the Data Analyzer 30, the Measurement Control Panel 32, and the Active Data Gallery 34. The Main Display area 24 may be switched between three differing displays using an appropriate selector 1) the Live Video window, 2) the Data Visualization window, and 3) the Database window. This will be described in detail below. By decomposing the invention functionality into major regions, the commonalities and idiosyncrasies of these major region's functions can be harnessed and leveraged to provide a much richer user interface. In addition, there are minor regions 21 in display area 18: the Quick Access toolbar 36, the Ribbon tabs 38 and Ribbon 40. Although these regions are also persistently displayed, they provide supplementary functionality and occupy smaller regions.

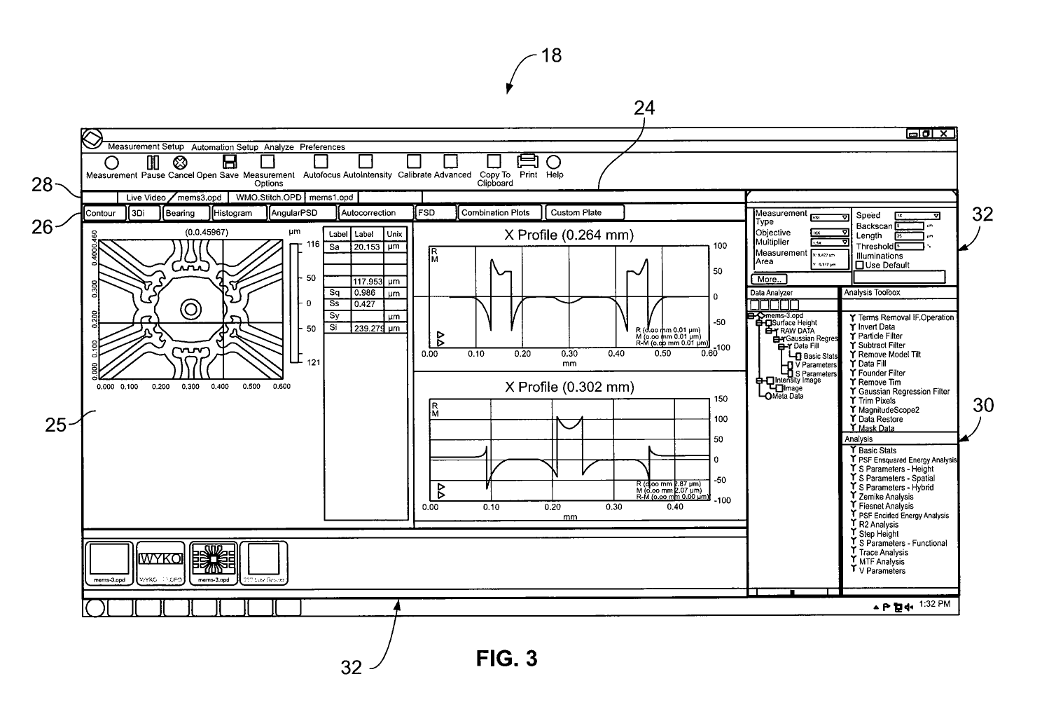

Referring now to FIG. 3 but also to FIG. 2, the display area 18 (which is shown as a simplified diagram of the major regions of the interface in FIG. 2) is shown in FIG. 3 as a snapshot of an actual screen. As previously noted, the major regions are always simultaneously displayed to the user regardless of the current operation of the device; this is also referred to as a tiled interface. The primary region of the major regions of the display 18 is the Main Display area 24, which may contain one or more of the following: a live video window, a data visualization manager, and a database window. FIG. 3 depicts the Main Display area 24 having a Main Display window 25, for example, showing a contour plot of previously collected data. The Main Display area 24 has an associated Data Visualization taskbar 26, which is used to control the data that is displayed or plotted in the Main Display window 25 as well as Display tabs 28.

Continuing with FIGS. 2 and 3, of the application's display 21 also contains minor regions: the Application Menu Button 39, Quick Access Toolbar 36, Ribbon Tabs 38, and Ribbon 40. Another important aspect of the user interface design is the use of persistent ribbon menu elements in Ribbon 40. These elements represent critical or commonly used functions that are always present on the ribbon 40, regardless of the current ribbon menu selection. As well, the Application Menu button 39 provides quick access to many of the important application functions such as taking a measurement, working with processing sequences (i.e. recipes, or pluralities of processing elements), and applying an automation sequence.

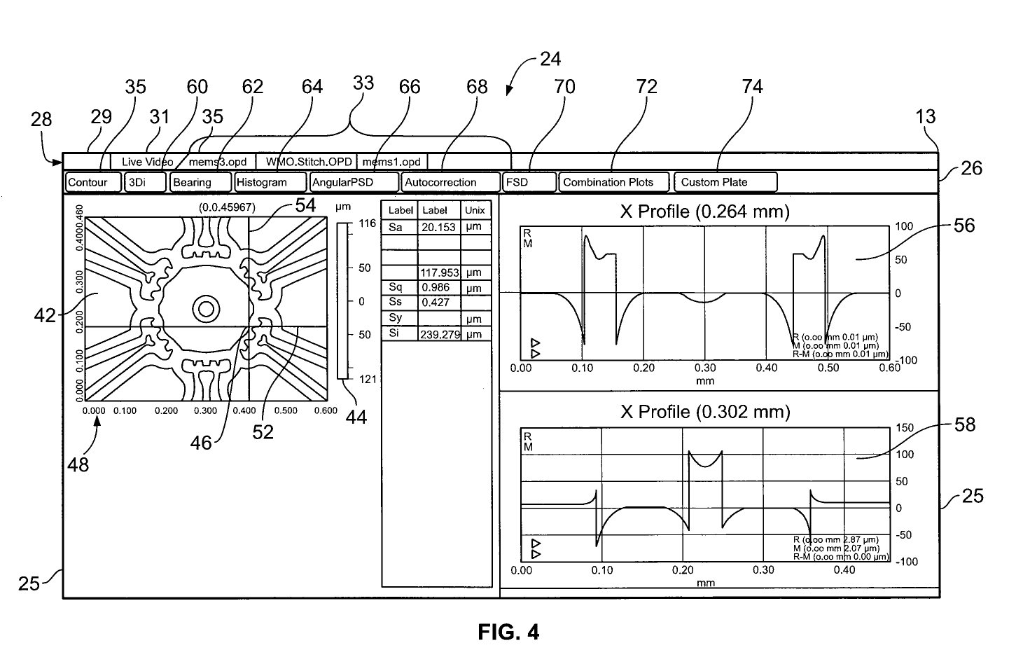

Referring now to FIG. 4, the Main Display area 24 of the screen 18 is a multipurpose area that can display different types of information dependent on the mode the program is in (Measurement mode, Analysis mode, and Data/Database view mode). The mode may be selected by the user from the Display tabs 28 or selectors. Thus, the user can quickly change modes by clicking on the Display tabs 28 thereby changing the information shown in active display area shown as Main Display window 25. The Main Display window 25 may display 1) the Live Video window by selecting the Live Video tab 31 in the Display tabs 28, 2) the Data Visualization window by selecting any of the Dataset tabs 33 in Display tabs 28, and 3) the Database window by selecting Database tab 29 in the Display tabs 28. For example, when setting up for a measurement, the user can switch to Live Video with tab 31. When a measurement is complete, the display may be configured to automatically switch to the Data Visualization window to display the new dataset, or by selecting any one of the Dataset tabs 33. Alternatively, the user can select a previous dataset for analysis by selecting the desired Dataset tab 33. Also, the user can select the Database view with tab 29 to monitor results during a long automated run wherein each measurement results in a new record logged to the database. This arrangement makes it easier for users to learn to use the software and requires fewer clicks to execute functions because all the main functions of the software are exposed at the top level. In addition to selecting a window by clicking a Display Tab, the user may select the Active Files Arrow at the right end of the Display Tabs 13 and select a previously acquired data file. The Main Display area 24 also has a Data Visualization taskbar 26 allowing the user to generate various types of plots in the Main Display window 24, along with a button for creating custom plots.

In addition to independently displayed tab-selected views, the invention allows for split view of these displays when needed. So, for example, it is possible to display the Live Video and Data Visualization windows simultaneously as tiled (side-by-side) non-overlapping windows (not shown).

Continuing with FIG. 4, the Main Display window 25 is currently showing previous measurement mems-3.opd file 35 as shown in Display tabs 28. The plot that is being displayed is a contour plot 35 as selected in Data Visualization taskbar 26. The contour plot is comprised of a colorized top view of the sample's surface (shown in grayscale) 42 with x and y scales 48, 50 in millimeters (mm). The height and depth of the colors associated with this color map are shown in color bar 44 in micrometers (μm). In addition, the cursor positioned at a point in the sample display shown as a shaded 2-D plot 46 has associated axes: x-axis 52 and y-axis 54, which are used to produce X Profile plot 56 and Y Profile plot 58. The profile plots show the height and depth of the surface in micrometers (μm) as well. The user may select a number of different plot types from the Data Visualization Taskbar 26 such as a 3Di plot 60, a bearing plot 62, a histogram plot 64, an angular power spectral density (Angular PSD) plot 66, an autocorrelation plot 68, and a power spectral density (PSD) plot 70. In addition, the user may create combination plots 72 and custom plots 74.

As well, the Main Display window 25 may be divided by the user into selected regions to create a custom plot layout. For example, when the user is in custom plot layout mode she may select to divide the Main display window 24 into two regions (an upper and a lower region) by selecting to add a horizontal division. The user may select one of these regions, for example the upper region, and further divide it into two subregions (a left region and a right region) by selecting the addition of a vertical division. This custom plot layout tool allows successive horizontal or vertical splitting of the display window 25 into a custom plot layout. Each region or subregion can be assigned unique characteristics, such as a plot type, parameters, tables, metadata, and the like that can be saved to create the custom plot layout template which may be recalled later and populated with surface data and other information, including analysis of the same.

In another embodiment according to the present invention, the user may draw a path in the 2-D plot 46 between two points to select one or more unique profile plots such as 56, 58, however, with the profile shown according to the user selected path rather than in, for example, the X or Y direction (not shown). This allows for any path selected by the user in the 2-D plot 46 to show an accompanying cross-section plot that may be updated in real-time as the user draws the path.

The user may also display at least two plots within the Main Display window 24, which may show different representations derived from the same surface data. The two plots may be linked such that as the user selects a region for viewing in the first plot, the second plot is accordingly shifted to show the same selected portion in the second plot as in the first plot in real-time.

In another embodiment the user may select a template (i.e., a region of a plot) for matching in a template matching mode. The region selected by the user is then matched over some set of surface data (such as the current plot from which the user has defined or selected her template). This matching or correlation process finds and indicates one or more regions similar to the user selected template. The template region may also be reselected for tuning. As well, the user can select any matched region for inspection in a larger plot with a single input operation allowing her to quickly inspect all of the similar matched regions located.

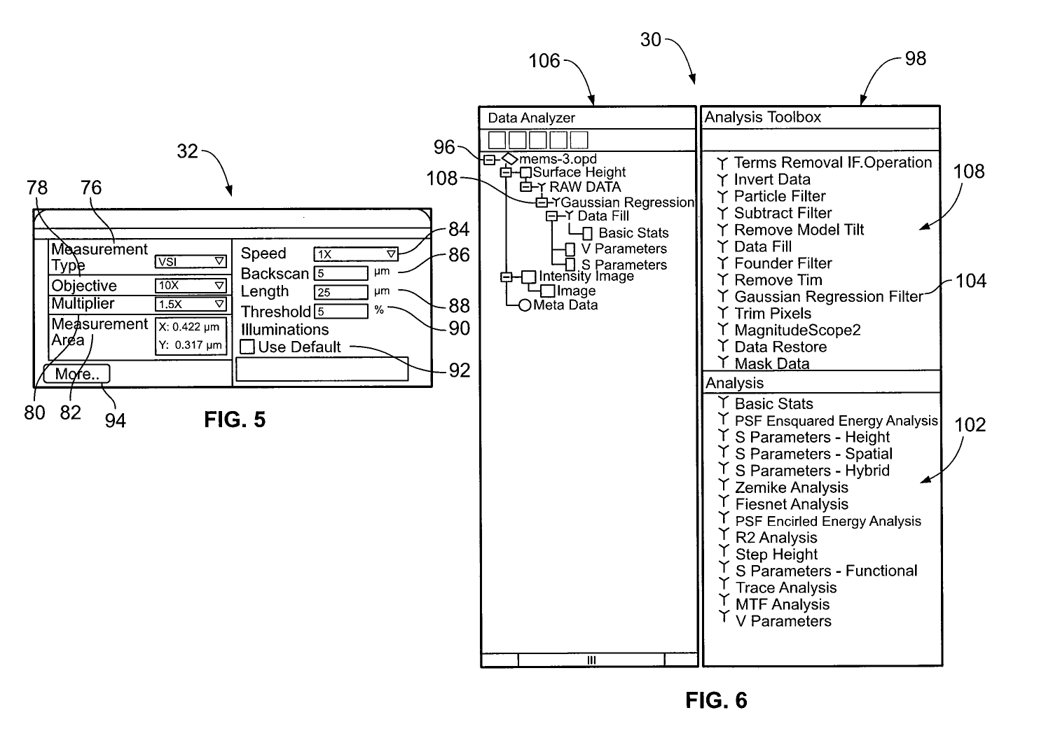

Referring now to FIG. 5, the Measurement Control panel 32 is shown. The Measurement Control Panel 32 controls the primary settings for the active measurement. This can be done by using the controls of the Measurement Control pane 32, for example, by selecting measurement type (VSI, PSI, or intensity) 76, objective 78 (the magnification of the optical profiler), multiplier 80 (the overall magnification of the system), the measurement area 82 (the vertical length and/or width scanned during the measurement), the speed of the measurement 84, back scan depth 86 (μm), length 88 (μm), threshold 90 (in percent), and illumination 92 (default, or by color). In addition, there are advanced settings available in a dialog box through the More button 94.

Turning now to FIG. 6, the Data Analyzer window 30 is shown. The Data Analyzer window 30 controls the filters and analyses applied to the associated dataset 96. This allows the user to easily apply customized processing step or steps (i.e. a processing sequence), which may be, for example, a default processing sequence (pre-defined as part of the invention) or a user saved processing sequence. The steps of the processing sequence may be applied real-time on the surface data as it is collected. For example, the user could select a filter in the analyzer window and specify the real-time rather than post-processing application of the filter. This can provide several advantages, including allowing the system to improve image quality prior to completing the full scan of the sample. Full scans can take several hours, with the possibility of generating images of little value to the user due to several operational factors known in the art. Real-time processing according to the present preferred embodiments can therefore operate to correct imaging parameters and thereby minimize the occurrence of acquisition of potentially useless images.

The processing sequence extracts key information such as various parameters of interest from the processed surface data, for example mems-3.opd 96. The Data Analyzer 30 is a major region and is, therefore, persistently displayed. The right pane known as the Analysis toolbox 98 consists of a list of selectable filters 100 and analyses 102 and displays a comprehensive list of filters and analyses. For example, the user selects a processing element such as Gaussian Regression filter 104. The filter may be applied to the active surface data set in the left pane 106 such as to the surface height raw data 108. Alternatively, the filter could be applied in real-time as the surface data is collected. The results of the application of the processing elements (i.e. the filters and analyses in the Data Analyzer 30) yields a representation of the surface data or processed surface data shown in the Main Display window 25 (see FIG. 3). As another example, the user may select an analysis from the analyses 102. The selected analysis, may comprise one or more processing elements that transform one or more separately collections of the surface data (i.e. surface data sets) to produce collections of processed surface data (i.e. processed surface data sets), for example, height histograms, filtered height histograms, a multiple-region statistical analysis, power spectral density, a cross hatch analysis, mean surface roughness, root mean square surface roughness, root mean square surface slope, mean summit curvature, summit density, surface texture aspect ratio, feature statistics analysis, surface texture skewness, surface texture kurtosis, average distance between highest and lowest points, step height, digitally filtered stylus analysis, hypothetical Zernike wavefront analysis, a material volume estimate, a void volume estimate, and the like.

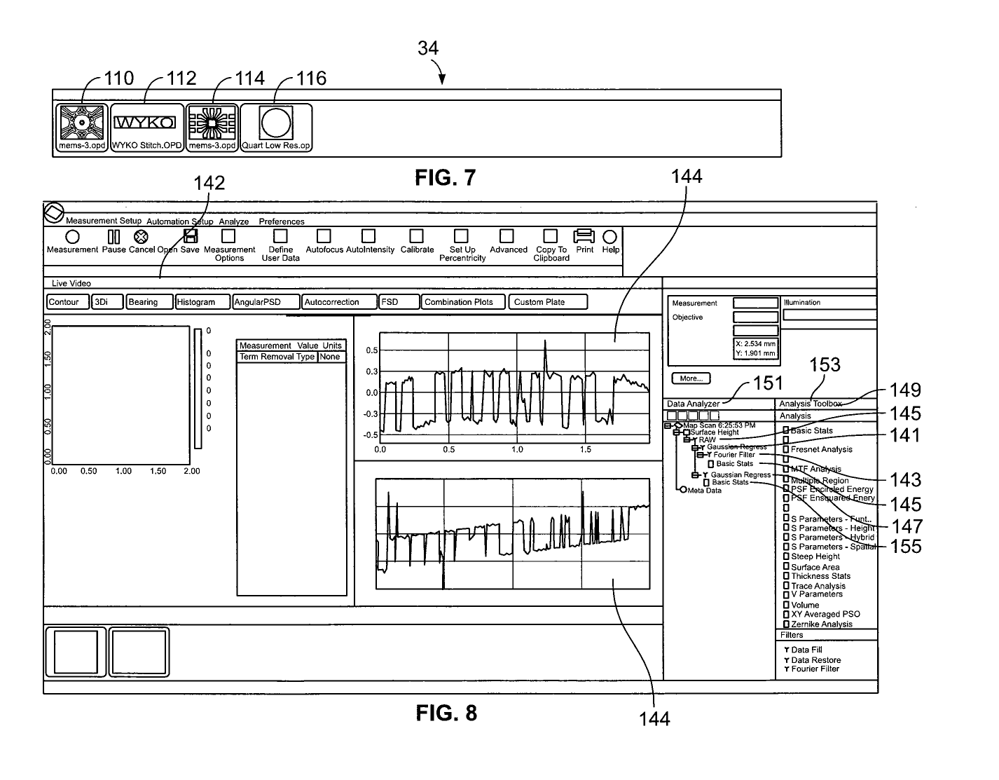

Referring now to FIG. 7, the Active Data Gallery 34 is shown. The Active Data Gallery 34 is a major region, thus, persistently displayed. It allows the user to quickly switch between currently open datasets, for example datasets “mems-3.opd” 110, “WYKO Stitch.OPD” 112, “mems-1.opd” 114, and “juarter Low Res.opd” 116.

Turning now to FIG. 8, the present invention may also be used for multiple or comparative analysis of single or multiple datasets. Shown is an example screen 140 where the basic surface statistics are computed and displayed side-by-side on a single dataset, largeMap.OPD as selected by tab 142. This single dataset has been filtered differently; for example, by using the processing elements shown in the data analysis region 151 which are selected from the analysis toolbox 153, such as the basic stats element 141, which is applied to the raw data 149 at processing blocks 143, 155. A group of processing elements may be applied to raw data 149 to form a processing sequence; for example, by performing terms removal 141 and a Fourier filter 143 to which basic stats 145 are then applied. The display of the X, Y profiles plot 144 is determined by the output of the selected processing element, for example, by selecting terms removal 141 which yields a display of the output of the terms removal processing element 141. Similarly, a second processing sequence operating on raw data 149 can be defined such as Gaussian regression 147 and basic stats(2) 155. The user may select any of the processing block representing a given processing element in either sequence (in this example both operating on raw data 149) to observe the output of the respective processing element. This way, the effects of each processing element can be compared on the same data set (as in this example) or between different data sets (not shown). User selection of the processing elements in the analysis toolbox 153 is used to graphically build a processing sequence as shown. These processing sequences, or “recipes,” can be saved as “recipes” for later application to the same surface data set or other data sets.

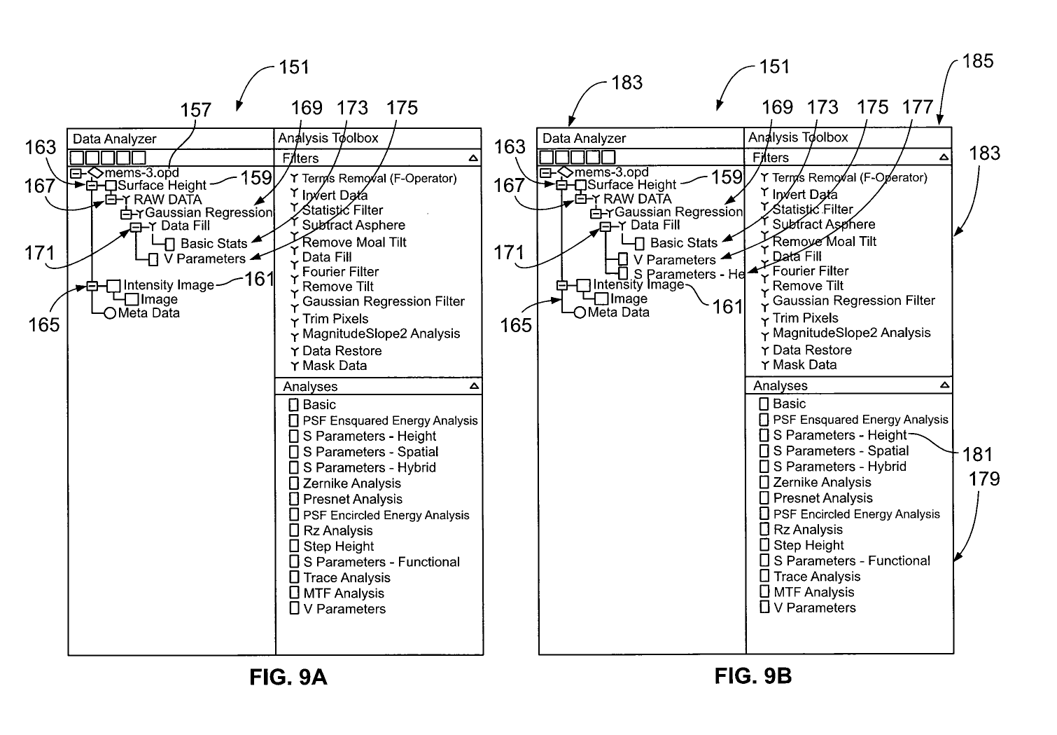

Referring now to FIGS. 9A and 9B, the present invention may also be used to create and associate one or more processing sequences (i.e., data flows) with a given data set thereby allowing the saving and recall of the processing sequence(s) with a given data set, or even a new data set. For illustration of how these sequences can be defined and associated, FIGS. 9A and 9B show use of the data analyzer portion of the GUI 151 during the definition of a processing sequence associated with, for example, data object “mems-3-opd” 157. For surface height analysis, for example in both FIGS. 9A and 9B, the user has selected an operation on the raw data 167, namely, a Gaussian regression filter 169. Thereafter, a data fill 171 is applied, and basic statistics 173 are generated. In addition there is a second branch (i.e., parallel processing sequence) including an additional processing element for computing “V parameters” 175 based on the output of the Gaussian regression filter 169 (again in both FIGS. 9A and 9B).

Turning more specifically to FIG. 9B, the process of adding one or more processing elements to a processing sequence (such as that shown in the ‘before’ screen shot of FIG. 9A) is quickly and easily performed in a single input operation such as a click and drag operation with a user input device such as a mouse as shown in FIG. 9B. The user may decide, for example to add another processing element to follow the V parameters processing 175 (thus taking input from the V parameters processing block output), for example, “S Parameters—Height” 177, as shown in FIG. 9B. To accomplish this, the user may select the S Parameters—Height processing element 181 from the “Analyses” frame 179 and drag it into the processing branch (parallel processing sequence) at the position of S Parameters—Height 177 processing block in the Data Analyzer frame 183. Thus, the user may select any of the processing elements in analysis toolbox 185 (comprising Filters frame 183 and Analyses frame 179) to graphically build one or more processing sequences as shown. These combined sets of processing sequences, can be saved as “recipes” that are associated with the current data set, as in this example mems-3.opd, and can be recalled along with the data set when the file is opened at a later time. In addition, the combined processing sequences may be recalled for later application to other data sets. Comparative analysis is enabled, for example, by the user selecting the V parameters block 175, or the S parameters height block 177, which will show the different surface heights calculated for these two different processing blocks on the raw data of mems-3.opd (not shown).

Thus the user can easily process surface data with all the required elements simultaneously available on the “top level” of the GUI. In other words, the GUI elements for the selection and ordering of processing elements (used to create user-defined processing sequences) are persistently visible with none of the major functional elements hidden. This type of “direct access” to the functions including processing elements provides a significant advantage over prior analysis tools. Rather than multiple stacked windows, each window/function/tree has a piece of real estate on the primary screen which can be characterized as having intelligent sectioning allowing the user to access functions and see results all at the same time. Furthermore, the user-defined processing sequences can be applied in parallel with two processing elements getting their inputs either from the same surface data, processed surface data, or output of a preceding processing element, as discussed elsewhere herein. In doing so, the processing or functional elements can be executed substantially simultaneously to efficiently output results, including plots, that a user may want to see side-by-side.

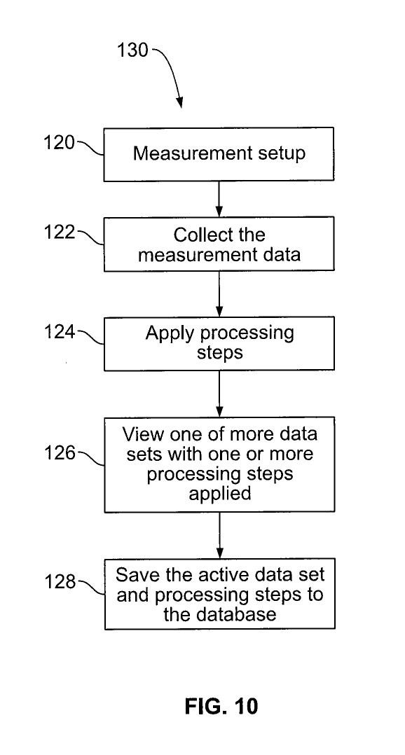

Referring now to FIG. 10, a method 130 of collecting surface characteristic data is described via a high level flow chart. In Block 120, the method includes performing measurement setup. The measurement setup step may utilize the measurement parameters pane 32 by selecting measurement type 76, objective 78, multiplier 80, the measurement area 82, the speed of the measurement 84, and so forth. (See FIG. 5 and corresponding description, supra) In Block 122, the method includes collecting measurement data. This may be viewed during data collection in the live video window 25. Then, in Block 124, processing step or steps (i.e. processing sequence) are applied to the currently collected data set. The Data Analyzer 30 may control the filters and analyses applied to the associated dataset 96 either during data collection (real-time) or post data collection. (see FIG. 6 and corresponding description, supra). The method 130 then includes Block 126: viewing one or more data sets in the Main Display area 24 with one or more processing sequences (analyzer recipes) applied (see FIG. 4 and corresponding description, supra). Optionally, in Block 128, the method includes saving the active data set and processing sequences to a database.

In addition, there are many other combinations of processing steps such as masking the sample before collection or the data after collection using a pre-defined or user-defined mask in the Analysis Toolbox 98, selecting any of a variety of plots for displaying the processed data using the Data Visualization Taskbar 26, and so forth.

It should be clear that there are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. For example, it will be manifest that various additions, modifications and rearrangements of the features of the present invention may be made without deviating from the spirit and scope of the underlying inventive concept. In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although many elements and components are described herein as physically separate modules, it will be manifest that they may be integrated into the apparatus with which it is associated. Furthermore, all the disclosed features of each disclosed embodiment can be combined with, or substituted for, the disclosed features of every other disclosed embodiment except where such features are mutually exclusive.

Various alternatives are contemplated as being within the scope of the following claims particularly pointing out and distinctly claiming the subject matter regarded as the invention.

What is claimed is:

1. A method of analyzing surface data collected by a surface analyzer, the data representative of a surface of a sample, the method comprising the steps of:
providing a graphical user interface (GUI) including a primary screen, the GUI enabling top level access at the primary screen to a plurality of functions including at least two data analysis functions;
applying a processing element to at least one of the surface data, a previously collected surface data, or a previously processed surface data so as to produce a processed surface data;
viewing one or more representations of the surface data or the processed surface data on the primary screen; and
wherein the functions are simultaneously and continuously controllable by the user from the primary screen during operation of the surface analyzer.

2. The method of claim 1 wherein the processed surface data has a surface information which is one or more selected from a group consisting of a surface location, a thickness, an intensity, a fringe modulation, a material composition, a reflected spectrum a force, an indentation, an adhesion, a hardness and an elasticity.

3. The method of claim 1 wherein the one or more processing elements comprise one or more processing sequences having a processing sequence order, wherein the one or more processing elements are selected and ordered from the data analysis functions of the GUI and wherein more than one processing sequence may be simultaneously accessible by the user from the primary screen during operation of the surface analyzer.

4. The method of claim 3 further comprising for the step of selecting the one or more processing elements of the one or more processing sequences, wherein selection of a processing element adds the processing element to a user-defined processing sequence, and subsequent selection of the processing element in the user-defined processing sequence displays at least one of a group consisting of: the one or more representations of the surface data, the processed surface data, the previously collected surface data, and the previously processed surface data; one or more parameters derived from the surface data, the processed surface data, the previously collected surface data, and the previously processed surface data; one or more measurements derived from the surface data, the processed surface data, the previously collected surface data, and the previously processed surface data; one or more analyses derived from the surface data, the processed surface data, the previously collected surface data, and the previously processed surface data; a surface data plot; and an output from the selected processing element.

5. The method of claim 4 further comprising the step of saving one or more processing sequences for a later processing of the same surface data or a different surface data.

6. The method of claim 1 wherein the processing elements transform one or more sets of the surface data or processed surface data using one or more of a group consisting of: a real-time filter, a post-acquisition filter, a data combining operation, a data masking operation, a frequency transform, an inversion, a subtraction, and an estimator.

7. The method of claim 1 wherein the processing elements transform one or more sets of the surface data or processed surface data to produce an analysis of said data in real-time and/or post-acquisition using one or more from a group consisting of height histograms, filtered height histograms, multiple-regions statistical analysis, power spectral density, cross hatch analysis, mean surface roughness, root mean square surface roughness, root mean square surface slope, mean summit curvature, summit density, surface texture aspect ratio, feature statistics analysis, surface texture skewness, surface texture kurtosis, average distance between highest and lowest points, step height, digitally filtered stylus analysis, hypothetical Zernike wavefront analysis, material volume estimate, and void volume estimate.

8. The method of claim 1 wherein the applying step includes applying, in parallel, at least one of the processing elements to at least two sets of surface data, or at least two of a group including surface data, previously collected surface data and previously processed surface data.

9. A surface analyzer comprising:
a sensor providing a surface measurement data corresponding to a sample;
a plurality of selectable processing elements configured for processing the surface measurement data;
a user interface having a display screen and a user input device;
wherein the processing elements may be selected individually or as a group, ordered by the user into a processing sequence, and selectively applied in real-time and/or post-acquisition to the surface measurement data to yield a processed surface data;
at least one representation of the processed surface data which is displayed on the display screen; and
wherein the selectable processing elements and the at least one representation of the processed surface data are simultaneously and continuously displayed on the display screen during the operation of the surface analyzer.

10. The surface analyzer of claim 9 wherein the sensor is one or more selected from a group consisting of a scanning probe microscope (SPM), atomic force microscope (AFM), an interferometric optical profiler, a confocal microscope, a surface profiler, an interferometric sensor, a contact probe, and a confocal instrument.

11. The surface analyzer of claim 9 further comprising a controller for positioning the sensor and at least one or more of a group consisting of a measurement setup, a real-time measurement interaction, a real-time filter application during surface data collection, and a surface data collection.

12. The surface analyzer of claim 9 wherein the processed surface data has surface information which is one or more selected from a group consisting of a surface location, a force, an indentation, an adhesion, a hardness and an elasticity.

13. The surface analyzer of claim 9 wherein the selectable processing elements are previously defined and comprise one or more of a user saved processing sequence and a default processing sequence.

14. The surface analyzer of claim 9, wherein the selectable processing elements process, in parallel, at least two sets of surface data.

15. The surface analyzer of claim 9 further comprising a plurality of processing sequences comprising one or more selectable processing elements and a selector for displaying at least two of the representations of the surface data and/or processed surface data on the display simultaneously.

16. The surface analyzer of claim 9 wherein the representation of the processed surface data comprises one or more selected from a group consisting of one or more parameters derived from the surface data, one or more measurements derived from the surface data, a surface data plot, a surface rendering, an output from a processing sequence, and an output from a processing element.

17. The surface analyzer of claim 9 wherein the processing elements transform one or more sets of the surface data or processed surface data using one or more of a group consisting of: a real-time filter, a post-acquisition filter, a data combining operation, a data masking operation, a frequency transform, an inversion, a subtraction, and an estimator.

18. The surface analyzer of claim 8 wherein the processing elements transform one or more sets of the surface data or processed surface data to produce an analysis of said data using one or more from a group consisting of height histograms, filtered height histograms, multiple-regions statistical analysis, power spectral density, cross hatch analysis, mean surface roughness, root mean square surface roughness, root mean square surface slope, mean summit curvature, summit density, surface texture aspect ratio, feature statistics analysis, surface texture skewness, surface texture kurtosis, average distance between highest and lowest points, step height, digitally filtered stylus analysis, hypothetical Zernike wavefront analysis, material volume estimate, and void volume estimate.

19. A surface analyzer comprising:
a sensor providing a surface measurement data from an object;
a display;
a user input device;
a plurality of processing elements for processing the surface measurement data; and
a primary screen on the display having visual regions comprising:
a data visualization window;
a measurement control panel;
a data analyzer window;
an active data gallery; and
wherein the visual regions are simultaneously displayed in a persistent location and size relative to the primary screen.

20. The surface analyzer of claim 19 wherein the data analyzer window provides the plurality of processing elements for processing the surface measurement data wherein one or more of the processing elements may be applied to the surface measurement data using the user input device to select the one or more processing elements and apply the one or more processing elements in a single user input device operation.

21. The surface analyzer of claim 19 wherein the plurality of processing elements form a processing sequence that is previously defined and comprises one or more of a user saved processing sequence and a default processing sequence.

22. The surface analyzer of claim 19 wherein the data visualization window provides a plurality of display modes for displaying a representation of the surface measurement data or one or more processed surface measurement characteristics wherein the display mode may be selected by the user input device in a single user input device operation.

23. The surface analyzer of claim 19 wherein the measurement control panel provides a plurality of control elements comprising one or more selected from a group comprising: a measurement type, a measurement area, a measurement multiplier, a measurement magnification, and a measurement illumination, wherein each and every control element setting may be selected by the user input device in a single user input device operation.

24. The surface analyzer of claim 19 wherein the active data gallery provides one or more selections for previously collected surface measurement data, wherein each and every previously collected surface measurement may be selected by the user input device in a single user input device operation.

25. The surface analyzer of claim 19 wherein the sensor is one selected from a group consisting of interferometric, contact stylus, and confocal instruments wherein the sensor is used for making surface characteristic, dimensional, and other microscopic measurements of the object.

26. The surface analyzer of claim 19 wherein the processing elements transform one or more sets of the surface data or processed surface data using one or more of a group consisting of: a filter, a data combining operation, a data masking operation, a frequency transform, an inversion, a subtraction, and an estimator.

27. The surface analyzer of claim 19 wherein the processing elements transform one or more sets of the surface data or processed surface data to produce an analysis of said data using one or more from a group consisting of height histograms, filtered height histograms, multiple-regions statistical analysis, power spectral density, cross hatch analysis, mean surface roughness, root mean square surface roughness, root mean square surface slope, mean summit curvature, summit density, surface texture aspect ratio, feature statistics analysis, surface texture skewness, surface texture kurtosis, average distance between highest and lowest points, step height, digitally filtered stylus analysis, hypothetical Zernike wavefront analysis, material volume estimate, and void volume estimate.
